(19) United States
(12) Patent Application Publication
(10) Pub. No.: US 2026/0019504 A1
(43) Pub. Date: Jan. 15, 2026

(54) SYSTEM AND METHOD FOR AUTOMATICALLY EVALUATING DATA ITEMS USING A MACHINE LEARNING MODEL

(71) Applicant: NICE LTD., Ra'anana (IL)

(72) Inventors: Shashikant NIPANIKAR, Pune (IN); Salil DHAWAN, Pune (IN); Rujuta CHITNIS, Pune (IN); Revati JADHAV, Vaduj (IN); Ashish POWAR, Gadhinglaj (IN); Abhijit MOKASHI, Pune (IN)

(73) Assignee: NICE LTD., Ra'anana (IL)

(21) Appl. No.: 18/772,497

(22) Filed: Jul. 15, 2024

(51) Int. Cl. H04M 3/523; H04M 3/22

(52) U.S. Cl. CPC H04M 3/523; H04M 3/2218

(57) ABSTRACT

A system and method are provided for evaluating data items using a machine learning model, including: producing, by a machine learning model, answers to questions applied to an input data item, where the questions and data item are input to the machine learning model; calculating a score for the input data item based on the produced answers; and transmitting one or more output data items to a remote computer over a communication network based on the calculated score. Some nonlimiting embodiments of the invention may relate to analyzing text data such as interaction transcripts in a contact center environment. In some embodiments questions may be included in a form and/or evaluation plan, and questions may include critical questions which are to be answered in the data item is to be assigned a non-zero scores. Questions may be organized in levels, and scores may be calculated based on the levels.

### FIELD OF THE INVENTION

The present invention relates generally to machine learning and generative artificial intelligence (AI) technology, and more specifically to evaluating computerized data items using a machine learning model.

### BACKGROUND OF THE INVENTION

Manual execution of quality assessment, for example of the output of AI processes, and control processes poses several pitfalls, including inconsistency, human error, and significant time and human resource investment. Manual reviews can vary in accuracy and thoroughness due to subjective interpretations and fatigue, potentially overlooking critical issues.

There is a need for intelligent and automatic quality assessment and systems and methods that may, inter alia, provide consistent and objective evaluations of the output of AI processes or other output, ensure a standardized approach across all assessments, and automatically and seamlessly perform automated quality control actions based on assessments or evaluation. Such intelligent and automatic quality assessment and systems and methods may be used to process large volumes of data quickly, identifying patterns and anomalies that may be missed by human reviewers. This not only enhance efficiency and accuracy but may also allows human resources to focus on more complex tasks that require human intuition and creativity.

### SUMMARY

Some embodiments may provide a system and method for evaluating data items using a machine learning model. Some embodiments of the invention may include, e.g., producing, by a machine learning model, answers to questions applied to an input data item, where the questions and data item are input to the machine learning model; calculating a score for the input data item based on the produced answers; and transmitting one or more output data items to a remote computer over a communication network based on the calculated score.

Some nonlimiting embodiments of the invention may relate to analyzing text data such as interaction transcripts in a contact center environment. In some embodiments questions may be included in a form and/or evaluation plan used to evaluate an interaction transcript or other data item, and questions may include critical questions which are to be answered in the data item is to be assigned a non-zero scores. In some embodiments, questions may be organized in a plurality of levels, and scores may be calculated based on the levels. In some embodiments, the machine learning model may be configured to produce or generate justifications or explanations for the answers provided.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows example computer systems remotely connected by a data network according to some embodiments of the invention;

FIG. 3 shows an example high-level architecture diagram according to some embodiments of the invention;

FIG. 4 shows an example graphical user interface (GUI) for form designing according to some embodiments of the invention;

FIG. 5 shows an example large language model (LLM) system for automatic assessments according to some embodiments of the invention;

FIG. 6 shows an example large language model prompt according to some embodiments of the invention;

FIG. 7 shows an example workflow for an automatic assessment process according to some embodiments of the invention;

FIG. 8 shows an example user interface (UI) for auto assessment plan generation according to some embodiments of the invention;

FIG. 9 is a flow diagram showing an example auto assessment plan generation process according to some embodiments of the invention;

FIG. 10 is a flow diagram showing a first example workflow for an auto assessment process according to some embodiments of the invention;

FIG. 11 is a flow diagram showing a second example workflow for an auto assessment process according to some embodiments of the invention; and

FIG. 12 is a flow diagram of an example method of evaluating data items using a machine learning model according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention may be used to automatically assess or evaluate data items such as interaction transcripts using a machine learning model or a plurality of models. In some embodiments, evaluations may be performed based on, or using questions provided as an input to a large language model or generative artificial intelligence model. For example, a form including a set of questions and a call or interaction transcript may be provided as inputs to the model, for example as part of a large language model prompt including, e.g., additional commands and/or data or information. The model may generate or output answers to the questions as well as, e.g., explanations or justifications to the answers generated, which may, e.g., be provided in a text format or file. Embodiments may score output answers or justifications provided by the machine learning model, and perform automated computerized actions based on calculated scores.

Unlike manual assessments of data items, interactions or call transcripts, involving human users evaluating data and ensuring accuracy and contextual understanding, auto assessments or evaluations according to some embodiments of the invention, which may be conducted or performed using machine learning or generative artificial intelligence models may use machine learning tools and techniques to provide unparalleled speed, scalability, and consistency, enabling to handle large volumes of data and eliminating human errors. Embodiments may improve machine learning technology by better evaluating the output for such technology.

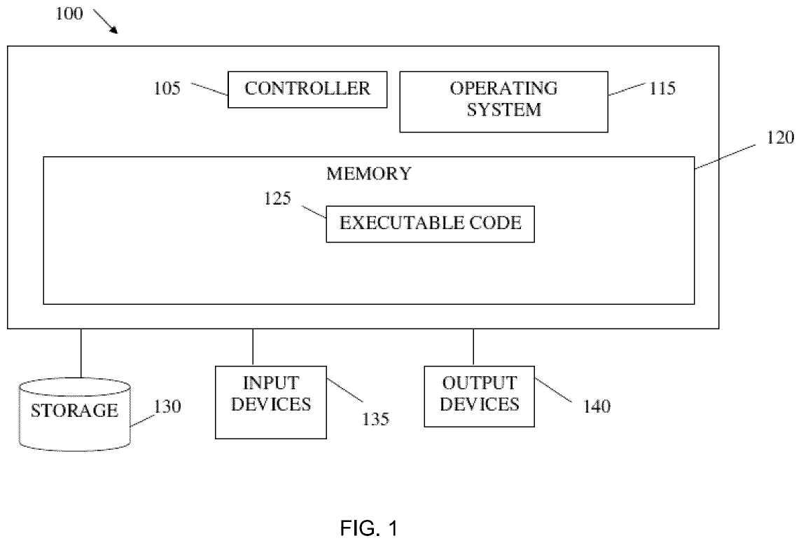

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

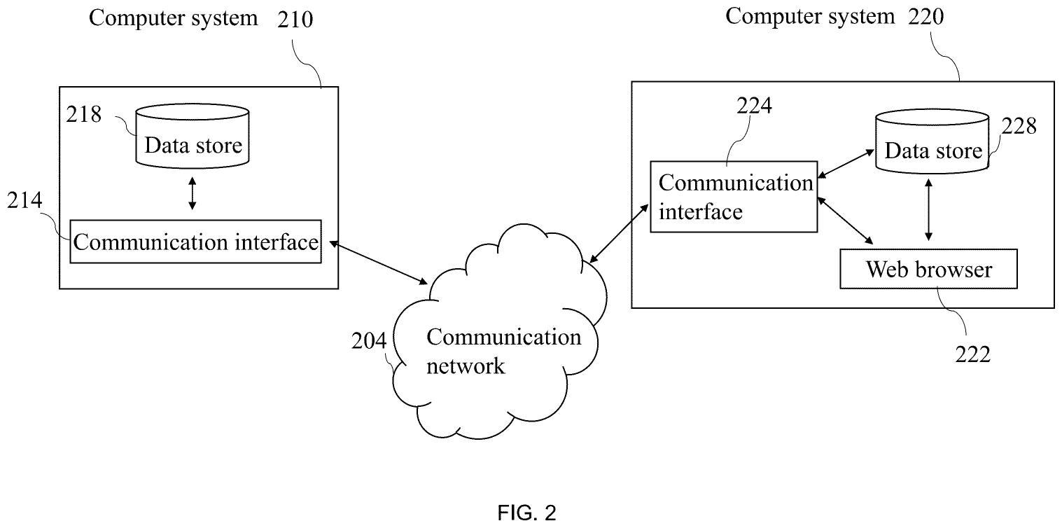

FIG. 2 shows example computer systems remotely connected by a data network according to some embodiments of the invention.

Some embodiments of the invention may include performing an exchange of data or data transfer between remotely connected computer devices. For example, remote computer 210 may send or transmit, over communication or data network 204, computerized data items, data elements, or data points of information such as for example application programming interface (API) calls, large language model prompts, interaction data and/or transcripts, form data, alerts or reports including calculated score or metrics, as well as additional computerized commands or requests—to computerized system 220, and/or vice versa. Each of systems 210 and 220 may be or may include the various components described with reference to system 100, as well as other computer systems, and include and/or operate or perform, e.g., the various corresponding protocols and procedures described herein. In some embodiments, computerized systems 210 and 220 may additionally perform a plurality of operations including for example sending and/or transmitting and/or collecting and/or receiving additional data to or from additional remote computers systems. One skilled in the art may recognize that additional and/or alternative remote and/or computerized systems and/or network and connectivity types may be included in different embodiments of the invention.

In some embodiments of the invention, computer systems 210 and 220 may communicate via data or communication or data network 204 via appropriate communication interfaces 214 and 224, respectively—which may be for example NICs or network adapters as known in the art. Computerized systems 210 and/or 220 may include data stores such as, e.g., 218 and 228 which may for example include a plurality of received data items, messages, requests, reports, and the like.

In the context of the present document, a “user”, “customer”, “agent”, “manager” and the like may refer to a computer system or device which may for example conform to the architecture of system 100, and which may communicate and/or perform exchanges of data with a physically separate or remote computer or server (which may conform to the architecture of system 100 as well)—for example over a communication or data network and using communication protocols as known in the art. In some contexts, a “user”, “customer”, “agent”, and the like may refer to a human operating the computer system, for example using an appropriate input device and/or user interface (such as for example as part of generating and transmitting computerized data, such as for example call or interaction data which may be evaluated or assessed according to some embodiments of the invention).

An “interaction” as used herein may refer to an exchange of data, or to a data based communication between computer systems performed over a data or communication network. Some example interactions according to some embodiments may be or may include, e.g., voice interactions or calls, or over internet protocol (VoIP) interactions, which may involve the real-time transmission of voice communications over the internet between remotely connected computers. These interactions rely on a series of network communications that encompass various computerized data items, such as for example voice packets, which carry digitized and compressed audio signals, signaling information for call setup and teardown, control messages for managing connection parameters, and the like. Additionally, these interactions often include metadata such as caller ID, timestamps, session duration, and so forth.

Some nonlimiting example embodiments of the invention may relate to interactions and/or to interaction transcripts describing or associated with voice interactions or calls. Different embodiments of the invention may relate to computerized data items or elements unrelated to interactions or calls. One skilled in the relevant arts would recognize, for example, that some nonlimiting embodiments of the invention may relate to automatically evaluating or assessing computer executable files which may or may not be human readable—and to performing automated actions relating to these executable files based on evaluation or assessment results. Additional or alternative embodiments may be realized.

A service or microservice as used herein may refer to a discrete and independently deployable unit of a computerized system (which may be composed of a plurality of software and/or hardware components) that may perform a specific technological function or set of such functions.

Some embodiments of the invention may allow evaluating or assessing data items using a machine learning model, large language model (LLM), or generative artificial intelligence (GenAI) model, such as for example evaluating and/or scoring interactions or transcripts generated for interactions using an LLM providing answers and justifications to questions, e.g., according to the various protocols and procedures described herein.

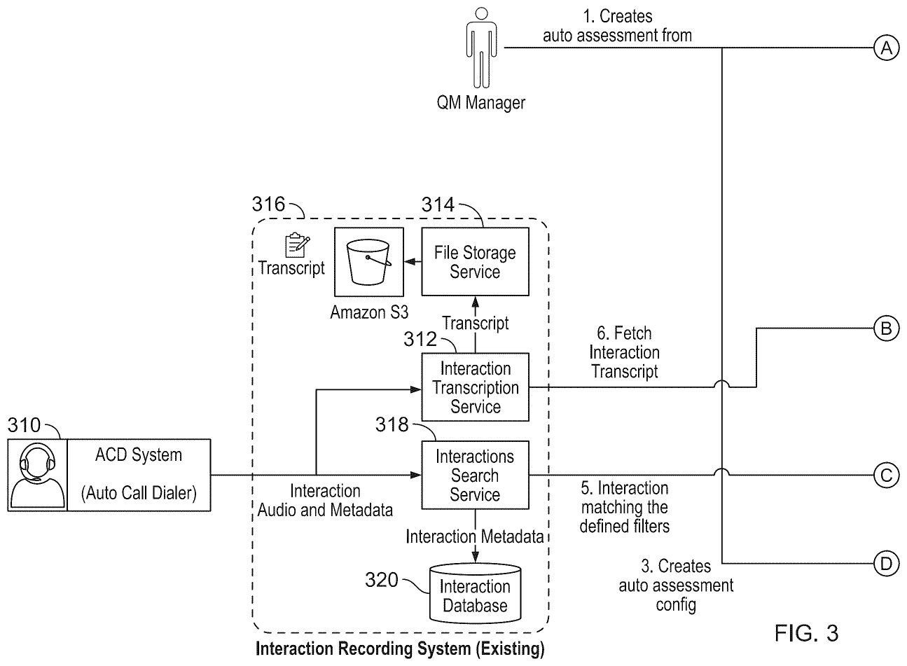

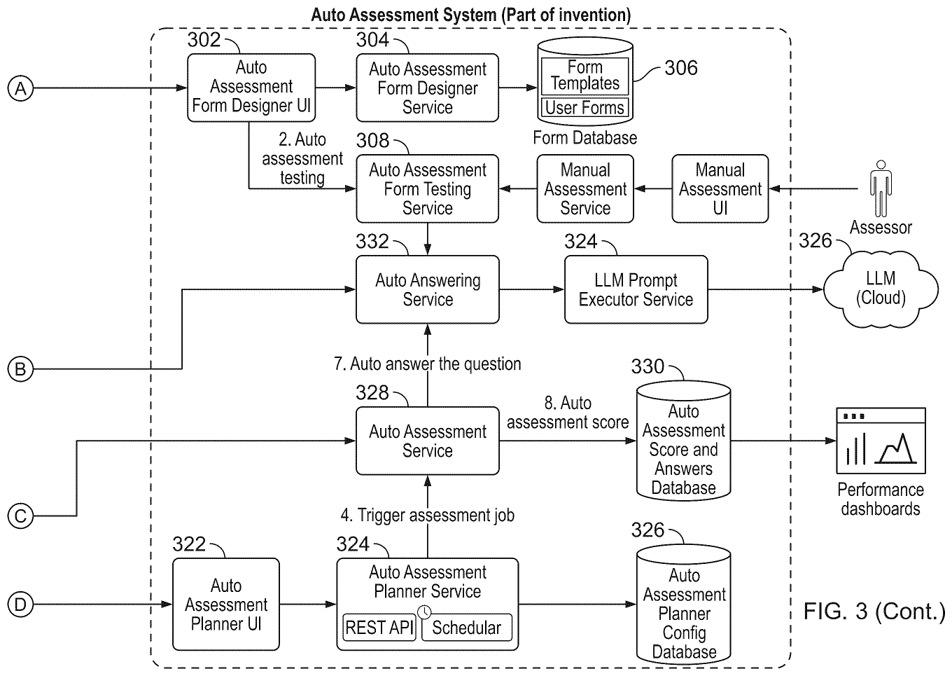

FIG. 3 shows an example high-level architecture diagram according to some embodiments of the invention.

An auto assessment form designer user interface (UI) 302 may be responsible for providing a user interface for creating auto assessment forms and/or questions which may be used for evaluations or assessments of data items by a machine learning model or LLM. For example, the auto assessment form designer may fetch pre-defined form templates using dedicated application programming interfaces or application programming interfaces (APIs) (which may be for example representational state transfer (REST) APIs) which may allow users to select them as templates. A user, quality management manager, or system administrator may create a form, e.g., using an input device or computer such as for example described in FIGS. 1-2, by selecting and editing one of the templates or prepare a new form from scratch. Once a form is created and/or edited, the application may allow the user to save the form and store it in computer memory.

An auto assessment form designer service 304 this service may be responsible for managing the auto assessment forms which may include questions, tiers or levels of questions, and the like, which may be input to an LLM and be scored in order to evaluate data item such as, e.g., described herein. The service may expose relevant REST API endpoints, which can be used to create, update, read and delete auto assessment forms. For example, this service may be used by auto assessment form designer UI, for example to allow user create forms. The service may save and/or store forms in a corresponding form database, and may for example run or be executed in a cloud environment, such as for example in a docker on the Amazon web services (AWS) elastic cloud (EC) or EC2 environment, where it may be managed, e.g., using AWS elastic container service.

A form database 306 may e.g., store form templates and user created forms according to some embodiments.

An auto assessment form testing service 308 may be responsible, e.g., for testing and/or performing quality control of auto assessment forms. The service may expose relevant REST API endpoints which may be used to trigger the testing of auto assessment forms. The API may return the testing results. In some embodiments, this service may expose API endpoints according to a request or command by auto assessment form designer UI, to allow testing of the created forms. The relevant API may receive a selection of testing methods and/or relevant parameters as input, which may be passed or sent to a testing algorithm. Once the testing algorithm terminates, testing results may be returned as a response of the API call. The testing algorithm may use REST APIs exposed by an auto answering service.

In some embodiments, form testing and/or performing quality control of auto assessment forms may be performed using a given data item or interaction, and may include for example generating, by a machine learning or large language model (LLM), a first set of answers to questions included in a given form, as well as receiving a second set of answers or replies by a human assessor to the same questions or form—where the form may be applied to the relevant data item or interaction. Some embodiments may display the two sets of answers, e.g., side by side on a user interface, and a user such as for example a quality manager may confirm or approve the form, e.g., if the two sets of answers or replies match or correspond to each other, or reject/revise the form or questions if the two sets of answers or replies do not match or do not correspond.

In some embodiments, form testing may be performed using a plurality of data items or elements, or interactions, and may include or involve generating, by an AI process such as an LLM, answers or replies, or sets of answers or replies to questions in the relevant form, where the form may be applied to the plurality of relevant data items or elements, or interactions. Some embodiments may display the multiple sets of answers on a user interface, and a user such as for example a quality manager may confirm or approve the form, e.g., if the sets of answers describe the data items or interactions in a satisfactory manner, or reject/revise the form or questions if needed. For example, a user or quality manager may be dissatisfied with some answers produced by the LLM, and may, e.g., refine or change the question according to or based the justification for answer provided by the LLM (for example in a trial-and-error fashion). Changing or updating the questions based on LLM answers and/or justifications may be performed in an iterative manner, e.g., until the user or quality manager is satisfied with the results.

Additional or alternative form or question testing operations or procedures may be included in different embodiments of the invention.

Some embodiments may include routing, by an automatic call dialer (ACD) the call to an agent computing device.

An automatic call dialer (ACD) 310 may be a system which may accept incoming call or digital interaction data and route calls or interactions to entities, devices, or agents. For example, this component may accept and route an incoming call to an agent computer or computing device which may, e.g., be transcribed and/or used as an input data item for evaluations or assessments. The system may also facilitate and dial or perform outbound calls, e.g., from agents to the customers. In some embodiments, the ACD may allow the contact center to manage call or interaction or routing configuration—which may include settings, conditions, or criteria which may determine which call may be routed to which agent and/or computing device. ACD may be responsible for generating and/or sending the interaction media, data or information items to the interaction transcription service. The media or data items may be for example an audio file in case of voice interactions or text messages or files in case of digital interactions. In some embodiments, ACD may also be responsible for sending interaction metadata to interaction search service.

In some embodiments, the input data item comprises a transcript of a call.

An interaction transcription service 312 may, for example, be responsible for transcribing interactions, including, e.g., performing audio to text conversion—and may for example include speech to text products or services such as for example the Amazon Transcribe component. The transcription service may be responsible for making transcripts for available audio/digital interactions, for example upon receiving an appropriate API request. In some embodiments, the transcription service may monitor file storage service for new files such as, e.g., newly added audio or digital files or data items. For new audio files found, embodiments may perform a speech to text conversion and create a transcript for the file. For newly added digital text files and/or for newly created transcripts, embodiments may process raw messages to have a well formatted transcript. As part of the formatting, embodiments may identify a relevant actor (such as for example an entity/agent/customer) and start timestamps for each line or spoken content. For example, some ACD systems in some embodiments may provide automatic transcripts of interactions, e.g., as part of recording digital and/or audio interactions. Additionally or alternatively, digital channels including an instant messaging platform such as, e.g., the WhatsApp or Facebook Messenger platforms may provide formatted transcripts of digital interactions or chats. Transcript or text data may be stored using file storage service or component and the transcripts may be made available using an appropriate API request, e.g., specifying an identifier (interactionId) for the interaction for which a transcription is to be considered. One skilled in the relevant arts would recognize that input data items or data elements not limited to interaction transcripts may be used in different embodiments of the invention.

A file storage service 314 may be or may include for example a file management service. The file storage service may be deployed or may use, e.g., the AWS S3 cloud infrastructure to store files, data or information items. In some embodiments, a file storage service may act a façade on top of a separate cloud storage service or platform such as, e.g., AWS S3 and may separately maintain the access and metadata about the files, while the files themselves may be kept in AWS S3. Some embodiments may provide APIs to upload, download and search files in the files that are kept on S3. The service will also enable deleting files by the end user.

An Amazon S3 component 316 may be a nonlimiting example file or data storage service which may be used in some embodiments, e.g., as offered by the AWS cloud service provider. Additional or alternative file storage services or platforms may be used in different embodiments.

An interaction search service 318 may be responsible for storing interaction metadata, and for providing ability to search interactions and/or data or metadata in memory (including for example searching by users, teams, skills or topics, duration, channel, date range and other search criteria, and/or additional information such as for example provided in example data structures herein) upon an appropriate API call.

An interaction database 320 may be a database of a contact center where all the data of the interactions may be stored. Additional or alternative data or information, including, e.g., users and usernames, teams, tenants, and skills/tags associated with or users may also be stored in this database (see also example data structures herein).

An auto assessment planner user interface (UI) 322 may be for example a UI application, responsible for providing user interface for planning an auto assessment plan or process. The application may allow, e.g., a user or quality assessment (QA) manager to define for example filter criteria for interactions that may be auto assessed and/or for entities or agents whose interaction may be auto assessed, and to select a form or forms which may be used in the plan or process. For example, once a QA manager saves the auto assessment plan or configuration, the UI application may call the REST APIs provided by auto assessment planner service, which may save the new plan or configuration.

In some embodiments, UIs may be implemented for example using the HTML, Angular, or ReactJS UI development frameworks.

In some embodiments, producing of one or more answers is triggered based on the predefined time interval.

An auto assessment planner service 324 may be responsible for managing (including, e.g., fetching or loading, saving or storing, and the like) auto assessment plans or configurations, and also for triggering the auto assessment process—for example based on a predefined schedule, time period, or time interval (such as for example once an hour or once a day). In some embodiments this service may include two modules:
REST APIs: This module may expose REST APIs mainly to fetch, update, create and delete the auto assessment plans or configuration. These APIs may be used by auto assessment UI, for example to allow user to control the auto assessment process.
Scheduler: This module may run for example at the beginning of every predefined time interval or time period (e.g., hourly or daily) and may for example fetch all the auto assessment plans and configurations for all relevant tenants and may trigger or initiate auto assessment process and/or the providing or generating of answers or replies, e.g., for activated or scheduled plans. The auto assessment process may be triggered by invoking a REST API of auto assessment service, and the relevant auto assessment plan or configuration may be passed or provided as input to auto assessment service. In case there are no auto assessment plans or configurations available in store, e.g., for a given tenant, then the tenant may be ignored for the present scheduler run.

An auto assessment planner configurations database 326 may for example store auto assessment planner configurations and/or plans.

An auto assessment service 328 may be responsible for auto assessing data items or interactions and may be triggered and/or initiated for each auto assessment plan or configuration. This service may expose a corresponding REST API to execute the auto assessment process according to an auto assessment plan or configuration. As part of the auto assessment process, this service may fetch data items, data elements, or interactions matching the relevant filtering criteria, and for each data item or interaction, run an auto assessment procedure which may include operations such as for example further described herein. This service may also store answers and assessment scores provided as part of the assessment process in auto assessment score and answer database. In some embodiments, an auto assessment algorithm may include for example:
Fetching data items or interactions matching filtering criteria. This may achieved invoking the REST API exposed by interaction search service;
For each interaction fetched, running an auto assessment program or algorithm. This may be achieved by calling the REST API exposed by auto answering service, which may return the auto answered question in the response; and
Saving the assessment score and answer in auto assessment score and answer database.

An auto assessment score and answers database 330 may be the database that stores auto assessment scores or metrics and answers provided according to some embodiments of the invention.

An auto answering service 332 may be responsible for automatically answering or replying to questions relating to a data item or interaction. This service may be triggered or initiated for a given interaction, for example by exposing a REST API to execute an auto answering process or algorithm such as for example further described herein.

Some embodiments may include producing, by a machine learning (ML) model such as an LLM or generative model, one or more answers to one or more questions, wherein the one or more questions are applied to an input data item, and wherein the one or more questions and the input data item are input to the machine learning model.

In some embodiments, and as further discussed herein, an example auto answering or auto assessment or evaluation algorithm may include, e.g.:
Fetching an input item such as, e.g., a transcript for an interaction. This may be achieved invoking the REST API exposed by interaction transcription service and pass or provide a corresponding identifier (e.g., an “interactionId” which may be for example a number uniquely generated for each interaction) as an input;
Applying questions to the input data item, which may include, e.g., providing the input item and a plurality of questions (which may for example be included in a form as an input to the machine learning model or LLM, e.g., in a prompt such as, e.g., described herein;
Checking if there are any critical questions in the form, (such as for example based on a critical question prompt and/or requests and commands input to the LLM), and if so—then auto answering or replying to the critical question first (if not—then questions may be answered regularly). In some embodiments, auto answering a given question may be done for example by embedding the questions and interaction in an auto answering LLM prompt and executing the prompt, e.g., by calling the REST API of LLM prompt executor service;
Checking if any critical question was not answered or replied to by the LLM (which may be referred to herein as a critical question “failing”) and in case at least one critical question failed, some embodiments may set the entire assessment score or quality metric to zero and the process or algorithm may terminate. In case the critical question passed, some embodiments may proceed to answer subsequent questions in levels or tiers for example based on predefined dependencies between questions such as for example demonstrated herein (in some embodiments, all questions at a given level may be answered before proceeding to a next or subsequent level); Once all questions of all levels are answered, calculating an assessment score based on the answers.

An LLM prompt executor service 324 may be a micro service that may expose REST APIs responsible for execution of LLM prompts. This service may be implemented or deployed, for example, using the Java Spring Boot framework. Some embodiments may execute the provided LLM Prompt by calling the appropriate APIs of a corresponding LLM service or platform 326 such as for example mentioned herein.

Some components described herein may be deployed as a microservice or microservices inside a docker on AWS EC2 or ECS and/or may be managed using the AWS elastic container service and/or may be implemented in computer devices or computers such as for example described in FIGS. 1-2. Some of the components described herein may be implemented in a plurality of computer systems which may be remotely connected over a network (such as for example described with regard to FIG. 2) and/or in a cloud computing environment.

UI components or applications according to some embodiments may be built or established using UI development technologies or platforms such as, e.g., HTML, Angular, AngularJS, ReactJS, and the like. In some example embodiments, a given device or user may load the UI, and UI webpages may be downloaded run for example on an internet browser such as for example the Internet Explorer, Google Chrome, and Opera web browsers. Additional or alternative examples and UI frameworks may be used in different embodiments.

In some embodiments, various databases may be, e.g., a relational database (including, for example, MySQL, Postgres, and Oracle databases) and/or a document database, such as for example an elastic search or file system S3 databases, (which may include various files in various formats such as for example JSON data objects and/or additional or alternative file formats) and/or a combination of a plurality of different databases or repositories of different formats or configurations.

Some embodiments of the invention may include additional or alternative components like call routing components (such as, e.g., PBX components), audio recording components, digital chat message handler components, tenant management components, user management components, and the like.

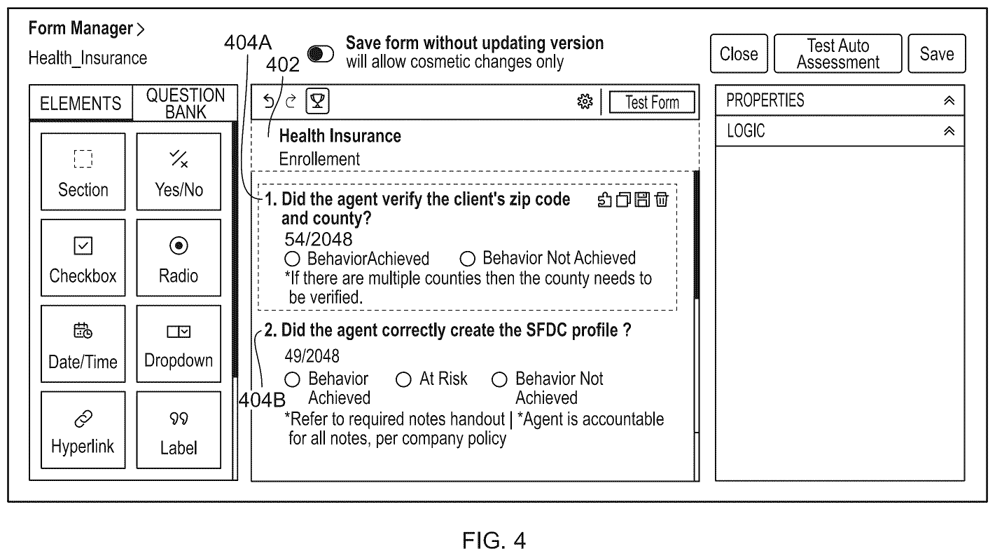

FIG. 4 shows an example graphical user interface (GUI) for form designing according to some embodiments of the invention.

In some embodiments, one or more of the questions are included in a form, the form generated using a graphical user interface (GUI).

In some embodiments, an example UI or GUI may be used, e.g., by an administrator or QM manager, to design, create, generate and store a form 402 including a plurality of questions 404A-B, e.g., according to the description further provided herein. In some nonlimiting examples, questions included in a form and/or entered into the form by a user using a UI according to some embodiments may be multiple choice questions, where an answer or reply to the question may be selected from, or may include one or more choices provided for the question. In some embodiments, an LLM may be configured to provide a selection of an answer to multiple choice questions, such as for example based on a corresponding prompt as further described herein. In accordance with the various discussions herein, a GUI according to some embodiments may be used, e.g., to define critical questions or to mark or select questions as critical, and/or to define levels or tiers of questions and/or to assign scores or metrics to questions or to answers to these questions.

An LLM according to some embodiments of the invention may generate answers to multiple choice questions based on appropriately engineered LLM prompts. For example, a prompt may include instructions or commands specifying possible or “allowed” answers to questions, such as the examples in Table 1:

TABLE 1

“
What greetings were used by the agent?
You can select multiple answers from the below options:
1. Good Morning
2. Thanks for calling our contact center
3. Good Afternoon
4. None
”

Additional or alternative question types and/or corresponding prompts may be engineered and/or used in different embodiments.

One designed, a form may be stored in an appropriate format in computer memory and/or a dedicated database. In some embodiments, the form is stored in a structured query language (SQL) database. Other nonlimiting example data formats may include, e.g., JSON objects, as well as data items or entries in NoSQL database formats such as for example MongoDB or Elastic search databases. Nonlimiting example form data structures or entities is further shown/provided herein (see, e.g., example data structure tables). One skilled in the art would recognize that various data structures and formats may be used in different embodiments.

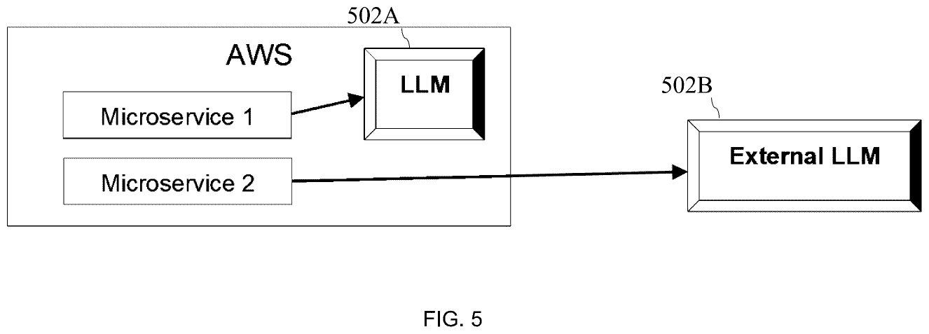

FIG. 5 shows an example large language model (LLM) system for automatic assessments according to some embodiments of the invention.

In some embodiments of the invention, microservices and server-side components may be for example deployed on in an Amazon web service (AWS) environment. Some embodiments may include one or more machine learning models or LLMs 502A which may for example provided by a generative artificial intelligence (AI or GenAI) platform or service such as for example the OpenAI, Azure, or Google GenAI platforms. In some embodiments, some machine learning models or LLMs (e.g., LLM 502B) may be deployed on the server-side and/or within AWS cloud environment, for example in addition to models external to AWS. Some embodiments of the invention may include or use one or more LLMs—where at least one first LLM may be used for prompt generation or construction, and at least one second LLM may be used for generating auto answers or auto replies based on a prompt provided to it as an input.

Some example machine learning models or LLMs which may be used in some embodiments of the invention may be or may include, e.g., the GPT-4 LLM by OpenAI, the PaLM LLM by Google, as well as, e.g., Anthropic's Claude LLM (e.g., Claude 3 Sonnet/Claude 3.5 Sonnet/Claude 3 Haiku/Claude 3 Opus), Meta's LLaMA LLM, Cohere's Command LLM, Amazon's Titan Text Premier, Mistral's Large, and the like, as well as additional or alternative LLMs or models developed from scratch.

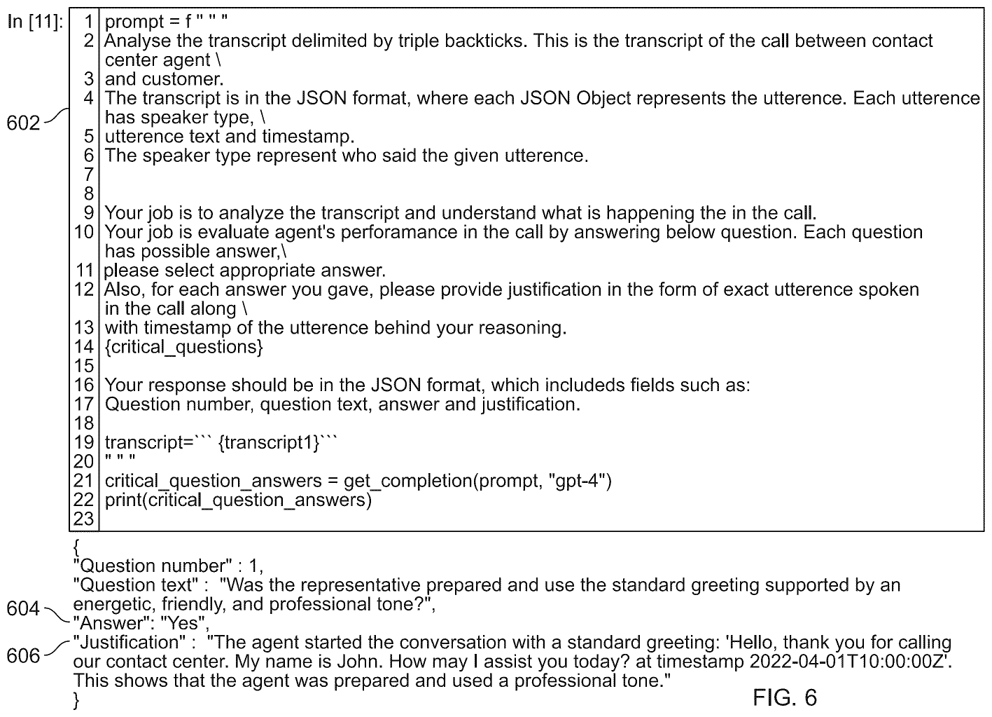

FIG. 6 shows an example large language model prompt according to some embodiments of the invention.

A prompt or LLM prompt as used herein may be an input or query designed to elicit a specific response or generate text from a large language model. In some embodiments, prompts may be provided in a raw text format and be input, e.g., to user interface of a relevant machine learning or LLM component or service (such as, e.g., GPT-4). In other embodiments, a prompt may be provided as an input file, such as for example a JSON file. Additional or alternative example prompt formats may be used in different embodiments. Prompts according to some embodiments may include various contents such as computerized commands, as well as, e.g., the input data item (such as for example an interaction transcript) to be evaluated. In other embodiments, the input data item may be provided, fetched, or input to the LLM or machine learning model separately and/or independently from, e.g., a prompt including instructions or commands.

In some embodiments, an LLM prompt 602 may include an explanation of a relevant data item or transcript's structure or format, as well as a plurality of processing instructions or commands for the LLM model to process the data item or transcript and provide an output corresponding to the data item received, which may be for example answers to questions included or embedded in the prompt. For example, the prompt may include an identification of entities or speakers (such as for example an agent and/or a customer) included in the data item or transcript; a description or format of the data item and/or its contents, including, e.g., timestamps and/or time units; a plurality of instructions or commands for data analysis by LLM—requesting, e.g., answers to questions included in the prompt and/or, e.g., a justification or explanations for the answers provided; a plurality of questions to be answered by the LLM, and the like.

In some embodiments, example prompts may include commands or instructions in a predefined format (such as for example “a form in JSON format, or an audio data item, is attached to this prompt. Answer questions included in the form; when multiple options are provided as answers, select one and only one of the answered provided”, and the like). Some embodiments may generate an LLM prompt for a given form—for example by identifying keywords or labels in the form. In one example, a form data item may include labels for questions such as for example “question 4 (critical): . . . ”. Accordingly, if a form includes critical questions or questions labeled as critical, embodiments may generate or create a critical question prompt or command (which may include, e.g., “answer critical questions first, and if an answer cannot be provided to a given critical question, terminate the process and do not answer additional questions”) based on the corresponding form, and may send or provide the critical question prompt as an input to an LLM. Otherwise, if no questions are marked as critical, embodiments may not include a command or instruction to answer critical questions in the relevant prompt. In some embodiments, prompts may be constructed manually, e.g., by a user, system administrator, or quality manager. Additional or alternative examples for prompt creation and/or engineering may be used in different embodiments.

In some embodiments, example prompts may be automatically constructed by an LLM—which may be for example an LLM different from the LLM used for answering questions, or the same LLM. An LLM may receive a data item such as, e.g., a form in JSON format, and may for example be trained (for example using a comprehensive dataset of example prompts, which may for example be labeled and/or include associations to keywords that may be included in the prompts, and for example using a reinforcement learning or reward function based training) to automatically convert the form into a corresponding LLM prompt depending on the contents of the data item (for example, given an input form in JSON format including critical questions, an LLM may be trained to output a critical question prompt such as, e.g., described herein). Additional or alternative procedures for automatically generating prompts may be used in different embodiments.

Based on LLM prompts, the relevant LLM may, e.g., output or generate replies or answers 604 to questions relating to a data item, transcript or interaction, and may provide an explanation or justification 606 for answers or replies provided. Additional or alternative answers and justifications or explanations may be used in different embodiments, some additional nonlimiting examples are provided herein.

Some embodiments may include producing, by the ML model, a justification to one or more of the answers.

For example, as described and/or illustrated herein, an LLM prompt according to some embodiments may include a command requiring the LLM to produce or generate a justification or explanation (such as, e.g., element 606) for the answers or replies generated or provided to a given question. An example LLM prompt or command for producing justifications by an LLM may be, e.g., “for each answer, please provide a justification or explanation in the form of an exact utterance in the call used for determining the answer, and a timestamp for that utterance”. For example, to a question such as, e.g., “was the agent professional and polite during the call?”, a given LLM answer may be “yes”, and a justification may be, e.g. “The agent started the conversation with a standard greeting: Hello, thank you for calling out contact center. How may I assist you today? at timestamp ‘2024-04-01T10:00:00Z’. This shows that the agent was polite and professional.” As for additional prompts considered herein, example justification prompts may be generated or produced, e.g., using predefined commands or strings stored in a dedicated database or databases, and/or constructed manually and/or automatically using an appropriately trained LLM.

Additional or alternative prompt contents and/or requests and commands may be used in different embodiments of the invention.

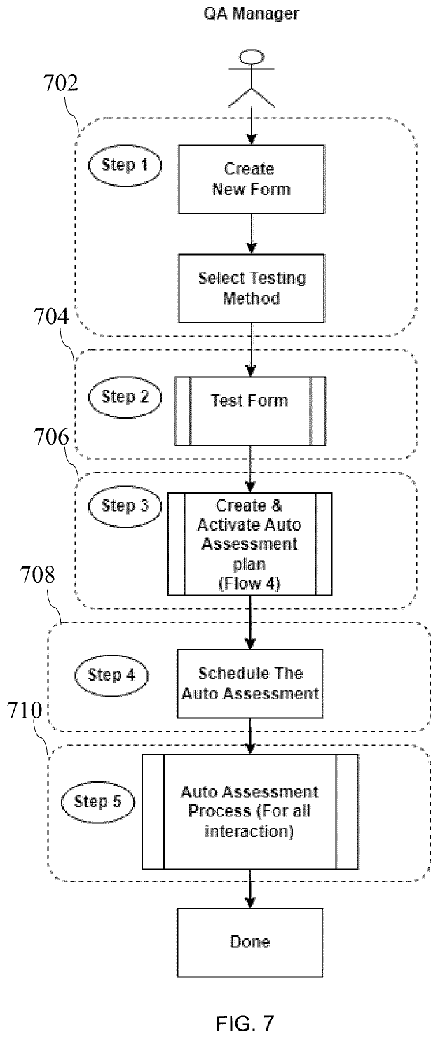

FIG. 7 shows an example workflow for an automatic assessment process according to some embodiments of the invention.

Step 1: form configuration 702. According to some embodiments, a form designer UI may be used to select a template from a plurality of form templates. Using a given template, embodiments may allow to create a form which may include questions of various types such as for example radio boxes, text boxes, choice boxes, critical questions, logical questions, and the like. In some embodiments, a UI screen may invoke or contact a relevant REST API endpoint of to store form data, which may be stored for example in form designer database.

Step 2: test form 704. in some embodiments, the form may be tested, such as for example described herein.

Step 3: create and activate auto assessment plan 706. As further discussed herein, embodiments may generate or create an auto assessment plan, which may include for example interaction data or segment selection criteria, an auto assessment form, and entities or agents chosen or selected for assessment.

Step 4: schedule auto assessment 708. In some embodiments, once all relevant selections are made and a plan is created (e.g., using an appropriate UI), some embodiments may save, store, schedule or activate the relevant plan. In some embodiments, a scheduler may search or check regularly (e.g., periodically, every N seconds) if entities or agents and/or interactions meet the assessment criteria included in an active plan. When a match is found (for example if interactions or agents meet relevant plan criteria, such as for example: if there are interactions in the relevant database that are longer than a threshold or 10 minutes, and if so, if they involve agents from an agent group of “technical support”), embodiments may initiate or start an auto assessment process such as for example described herein.

Step 5: auto assessment process (e.g., for all interactions meeting or matching assessment criteria) 710. some embodiments may use or include form questions and automatic answers provided for these questions to evaluate or score data items or interactions, such as, e.g., further discussed herein. As described herein, a form may be for example specified or included in an auto assessment plan and may allow calculating scores or computing metrics for a data item or interaction.

Additional or alterative workflow steps and/or operations may be included and used in different embodiments.

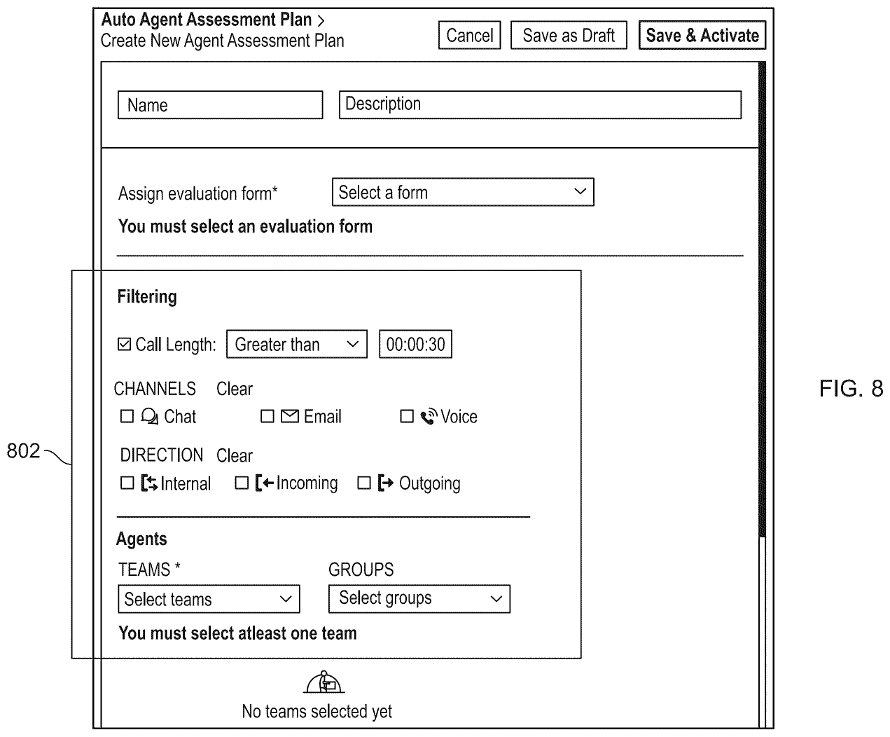

FIG. 8 shows an example user interface (UI) for auto assessment plan generation according to some embodiments of the invention.

In some embodiments, an example UI may include relevant GUI elements 802 for, e.g., defining filtering conditions or criteria based on call length, channels, directions, agent teams, and the like by an administrator or QM manager; see description of example workflow steps provided herein.

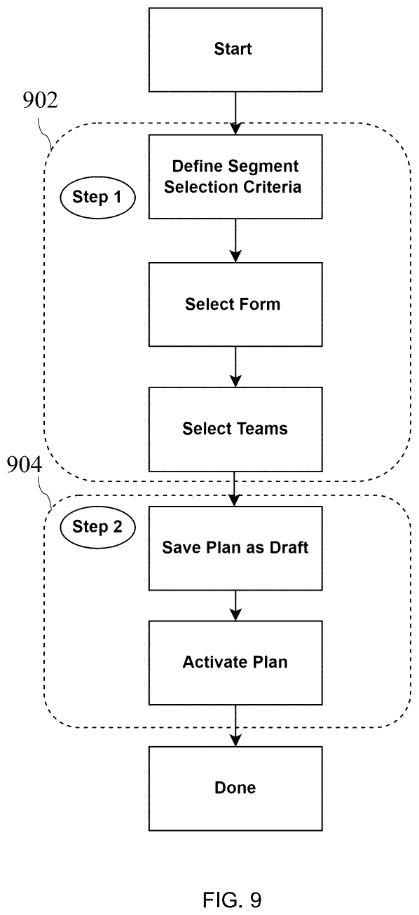

FIG. 9 is a flow diagram showing an example auto assessment plan generation process according to some embodiments of the invention.

In some embodiments, the producing of one or more of the answers is performed based on an automatic evaluation plan, wherein the evaluation plan comprises the form and one or more filtering conditions.

Step 1—configure assessment plan criteria 902: In some embodiments, using, e.g., a corresponding UI, a QA manager may select or specify conditions or criteria for selecting or filtering interactions are to be auto assessed. This may include, for example, factors such as interaction or call duration (e.g., whether the duration exceeds, falls short of, or matches a specified time, e.g., of X minutes), types of communication medium or channel, (such as chat, email, or voice), and/or interaction or call direction (for example inbound or outbound), and the like. Once filtering conditions or criteria are selected or chosen, the QA manager may select a form to be included or used in the plan. The form and/or questions creation or generation process is explained elsewhere herein. Once a form is selected, e.g., from a corresponding database and/or using a drop down menu, the QA manager may choose or select entities or agents whose interactions may be auto assessed. In one example, the QA manager may select one or many teams and/or group of entities or agents.

Step2—plan activation/management 904: following the setting of plan conditions or criteria for selecting interactions and/or entities or agents, the plan may be saved and stored in computer memory, and/or in a dedicated database (e.g., as discussed herein with regard to FIG. 3) and/or be activated—for example using dedicated UI commands or buttons which may be clicked on by the QM manager (e.g., using an input device or computer such as for example described in FIGS. 1-2) which may for example cause the plans to be scheduled for execution on a periodic basis such as for example described herein. In some embodiments, the UI may be used to request or communicate with a relevant REST API endpoint (see description herein) to fetch or load the previously saved plan or setup, which may allow the QA manager to adjust and/or edit and/or activate existing or stored plans.

Additional or alternative assessment plan creation operations may be used in different embodiments.

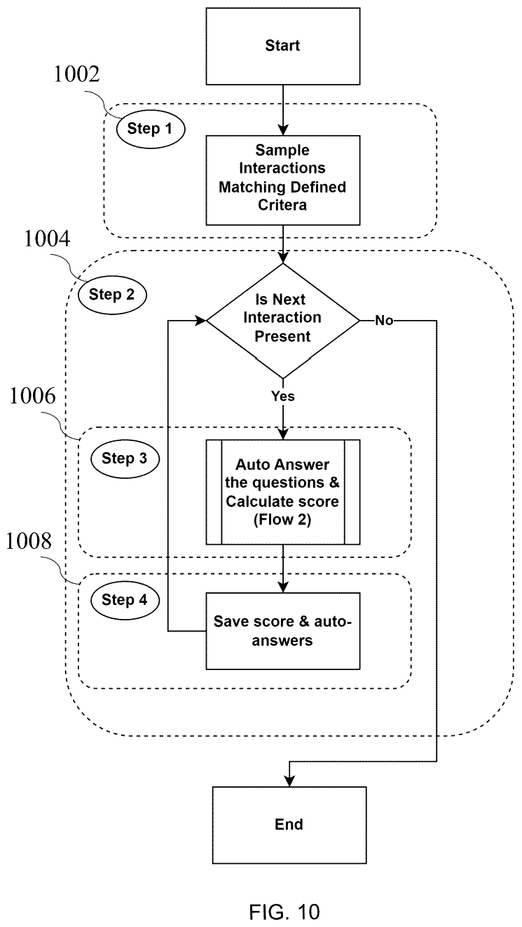

FIG. 10 is a flow diagram showing a first example workflow for an auto assessment process according to some embodiments of the invention.

In operation sample interactions 1002, some embodiments may retrieve a plurality of interaction data or information items that match the defined criteria.

In operation auto assessment 1004, some embodiments may verify or check (e.g., periodically, every N seconds) whether a “next interaction” or an interaction file or data item was provided as input for an assessment or evaluation process (e.g., by matching conditions or criteria of an activated plan). If the result is negative, the service or algorithm may be terminated. If the result is positive, and an input interaction is found, steps 3 and 4 may be executed (discussed elsewhere herein).

In operation auto answer questions and calculate score 1006, some embodiments may provide the answers and calculate or compute scores or quality metrics based on answers provided, as for example explained elsewhere herein.

In operation save score and auto answers 1008, some embodiments may save or store answers or replies and scores or metrics in a dedicated database.

Additional or alternative auto assessment steps and/or operations may be used in different embodiments.

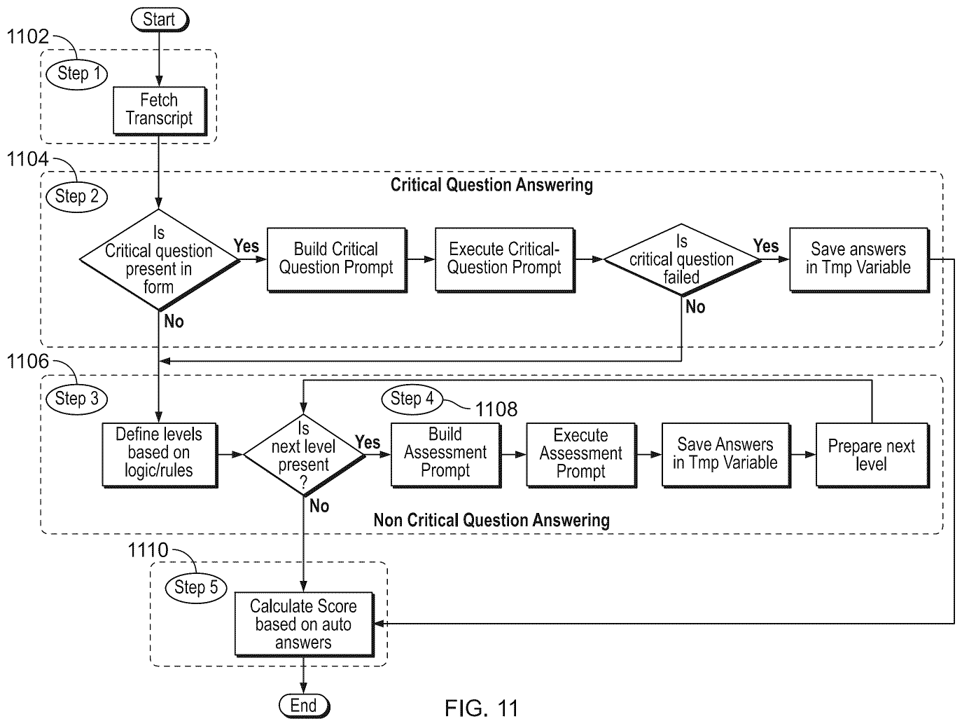

FIG. 11 is a flow diagram showing a second example workflow for an auto assessment process according to some embodiments of the invention.

In operation fetch transcript 1102, some embodiments, may generate and/or fetch interaction data such as for example a transcript using an interaction transcription component such as for example described herein.

In some embodiments, the questions are sorted in or classified into a plurality of levels, and the calculating of a score or quality metric is performed based on one or more of the answers corresponding to one or more of the levels. In some embodiments, the plurality of levels comprise a level of critical questions, wherein the calculating of a score comprises: if one or more critical questions are unanswered, assigning a score of zero to the data item.

A critical question as referred to herein may be a question marked or defined (e.g., in a form such as described herein) as a question for which a valid answer must be provided for a non-zero score or metric to be assigned to a given data item—or as a question serving as a condition for assigning a non-zero score for a data item. For example, considering an example input data item of a call or interaction transcript, a critical question may be, e.g., “did an agent answer the call?”, and a valid answer may be defined (e.g., in the corresponding LLM prompt or critical question prompt or query) as either “yes” or “no”. If an LLM produces an answer that is not either one of these valid answers, then the data item may be assigned a score or metric of zero, or may not be assigned a score at all. Otherwise, embodiments may proceed to answer additional questions, and may assign a score to the data item accordingly.

In some embodiments, critical questions may be included in a critical question prompt or prompt segment. For example, given a form including a plurality of questions and some questions marked as “critical”, some embodiments may generate a prompt specifying or including the critical questions and a command or instruction such as for example “start with answering the following questions or questions marked “critical”; if a critical question is given a selection of different possible answers, and no selection of an answer critical question is made, terminate the process, do not answer additional questions, and return an error message stating that “a critical question failed”. Additional example prompts may be engineered and/or used in different embodiments.

In some embodiments, questions of different levels or tiers may be provided in a plurality of separate and/or subsequent prompts to a machine learning model or LLM. For example, critical questions may be provided in a first LLM prompt, level 1 questions may subsequently be provided in a prompt in a separate prompt, e.g., if all critical questions were answered (otherwise the process may terminate), and so forth. Additional or alternative procedures for providing questions of different levels to a machine learning model or LLM may be used in different embodiments.

In operation critical question answering 1104, some embodiments may check or verify the presence of critical questions or of a level including critical questions in a form or questions to be answered. If critical questions exist, some embodiments may proceed to generate a critical question prompt. Then, some embodiments may execute the critical question prompt and analyze the response to determine, e.g., if any critical question failed (e.g., if some critical questions were not given answers be the LLM and are thus considered unanswered, and/or if invalid answers were given). If so, some embodiments may calculate or compute a score or metric of zero to the relevant data item (see, e.g., score calculating scenario I provided herein) and/or store the answer including, e.g., a justification in a temporary variable, and for example terminate the process. Otherwise, some embodiments proceed to the next step. In some embodiments, valid answers may be defined or specified for a given form, e.g., when a form is created, and may be stored in a relevant database entry (e.g., together with the form when the form is saved). For example, to a question such as, e.g., “did the agent greet the customer?” answers such as “yes” and “no” may be (pre)defined or (pre)specified as valid answers, and answers not including keywords such as “yes” or “no” may be determined as invalid answers. Some embodiments may receive an evaluation of a data item by an LLM and compare the answer by the LLM to the stored answers determined valid. If an evaluation or answer provided by the LLM does not match valid answers (for example, does not include keywords such as “yes” and “no”, in a case where these keywords are required and/or specified as valid for the relevant form), some embodiments may determine that the corresponding question “failed” and for example generate a corresponding error message. Otherwise, if the answer by the LLM matched valid answers, embodiments may, e.g., proceed to answer subsequent (e.g., non-critical) questions. Additional or alternative conditions or criteria for determining if answers or outputs provided by the LLM are valid may be used in different embodiments of the invention.

Additional levels may be included in addition and/or independently from critical questions. In some embodiments, levels may determine the order of answering questions by the machine learning model or LLM and/or the score associated or assigned to each answer to a question in that given level.

In operation additional question levels 1106, questions in the relevant form may be divided, sorted or classified into levels or tiers for example based on appropriate rules, conditions or criteria which may applied to the questions. According to some embodiments, a form may include some questions that may be hidden and that may become visible based on the answer to a previous or preceding question. Rules may be used to hide dependent questions based on a selected previous answer. For example, a rule definition for question 2 can be, for example: start with question 2 hidden; if an answer to question 1 is “no” then hide question 2; otherwise, if an answer to question 1 is “yes”, then make question 2 is visible. Table 2 shows example question levels based on rules applied to the questions.

TABLE 2

| Question | Rule | Depends on | Level |
|---|---|---|---|
| Question 1 | If answer is No, hide Question 2 | | L1 |
| Question 2 | | Question 1 | L2 |
| Question 3 | If answer is No, hide Question 4 | | L1 |
| Question 4 | If answer is No, hide Question 5 | Question 3 | L2 |
| Question 5 | | Question 3, | L3 |
| | | Question 4 | |
| Question 6 | | | L1 |

The levels defined are, e.g.:
L1: question 1, question 3, question 6
L2: question 2, question 4
L3: question 5
After processing or defining levels, subsequent steps may be performed for a plurality of questions in a plurality of levels.

Hiding as used herein may refer to, e.g., not including a question in a prompt to a machine learning or LLM, not sending a subsequent prompt including the relevant question to the LLM, or instructing an LLM not to answer or attempt answering a question unless certain conditions are met. For example, based on conditions and criteria provided in Table 2 above, embodiments may produce or provide an LLM prompt including only questions 1, 3, and 6. Based on answers provided to questions 1, 3, and 6 by the LLM according to the prompt, some embodiments may send or input an additional, second prompt including questions 2 and 4, to the LLM. Based on answers provided to question 4, and previously to question 3, embodiments may send or input a third prompt including question 5 to the LLM. In another example, the LLM may be instructed, e.g., using an appropriate command in an LLM prompt, for example to “read or to answer questions 2 and 4 if and only if and not before valid answers are provided to questions 1, 3, and 6; read/answer question 5 if and only if and not before valid answers were provided to questions 3 and 4. If no answer is given to one of questions 1, 3, and 6, terminate the process and return an error message”, and the like. The machine learning model or LLM may therefore answer questions in order based on their dependencies as defined using different conditions or criteria.

In operation non-critical question answering 1108, some embodiments may proceed to consider non-critical questions. Some embodiments may follow a process for each level. For example, some embodiments may generate or construct an evaluation prompt including the question from the specific level. Embodiments may then run or input the evaluation prompt to the relevant LLM, capture or receive the response or output to the prompt by the LLM, and store it (e.g., in temporary storage and in an appropriate format such as for example a JSON data object). Considering the example in Table 2, in level L1, auto answers given by the LLM in response to the relevant prompt may be, e.g.:
question 1: No
question 3: Yes
question 6: Yes
Accordingly, the next question level to be executed may be L2: question 4 (e.g., based on the answers provided to question 3; note that since the answer for question 1 is no, and according to the rule applied to question 2—question 2 may not be included in level L2 and may accordingly not be answered or considered by the LLM.

In operation calculate score based on auto-answers 1110, some embodiments may calculate or compute a score or quality metric for the relevant interaction file or transcript—which may for example be based on critical questions and/or after the LLM finished addressing or considering all levels of questions included in the form. Answers provided by the LLM and/or saved in computer memory may be used to calculate a final overall percentage score of the assessment. Both answers and scores may be saved or stored using a dedicated database (in an appropriate format such as for example a JSON data object). Some embodiments may verify that all relevant questions were considered or answered.

Some embodiments may include calculating a score for the input data item based on one or more of the produced answers. Some embodiments may include calculating scores according to different scenarios such as for example described herein.

Some embodiments may include, e.g., if one or more critical questions are unanswered, assigning a score of zero to the data item.

Scenario I: if critical questions failed or are not answered: some embodiments may analyze answers to critical questions to determine if any critical question failed, or if a critical question resulted in failure (e.g., unanswered or answered in an invalid manner). If a critical question fails, the assessment score or quality metric for the relevant data item may be set to 0 (e.g., overall percentage score of the form for that interaction may be 0%, the evaluated data item may be assigned a score of zero).

Scenario II: if critical questions passed and/or no critical questions were included in the form: in some embodiments, if all critical questions pass (e.g., if the model outputted or provided an answer and/or a justification the critical question) or if there are no critical questions present in form, then the overall percentage score may be calculated using dedicated formulas such as for example described herein.

In some embodiments, the calculating of a score is performed based on one or more of the answers corresponding to one or more of the levels.

For example, while defining or updating a form, a manager may assign scores to each question which may be associated or may be given, e.g., to a valid answer to that question (which may be for example an answer starting with “yes” or “no”), or to levels of questions. Thus, based on the auto answer by the LLM for each question, a predefined score may be earned or given to that answer based on the scores predefined by a manager. In some embodiments, if an invalid answer (e.g., not including or starting with “yes” or “no”) is provided by the machine learning model or LLM, that specific answer may receive 0 points. Additional or alternative conditions and/or criteria and/or procedures and protocols for assigning, defining, and calculating scores may be used in different embodiments. In one example, 3 questions may be assigned different scores, such as for example 5 points to question 1, 3 points to question 2, and 2 points to question 3. In another example, 2 levels may be assigned different scores: tier or level 1 including or corresponding to questions 1 and 2 may be assigned a score of 5, which may determine that a valid answer or reply to each of question 1 and question 2 may be assigned 5 points, and tier or level 2 including or corresponding to question 3 may be assigned a score of 3, meaning that a valid answer to question 3 may be assigned 3 points. Additional or alternative procedures for assigning scores may be used in different embodiments.

An example formula for calculating an overall percentage score for a given interaction or data item according to a corresponding form, may be, e.g.:

$$Overall Percentage Score of Form = ( Total Score Earned / Total Max Possible Score ) \times 100 \qquad ( Eq . 1 )$$

Where Total Score Earned may be a summation of scores earned for all questions answered, and Total Max Possible Score may be a summation of maximal possible scores for each question as, e.g., originally defined by a manager. Another example formulas for an overall percentage score may be further written as:

$$Overall Percentage Score of Form = ( ( \sum i = 1 n Score earned for question i ) / ( \sum i = 1 n Max possible score for question i ) ) \times 100 \qquad ( Eq . 3 )$$

In one score calculation example, a form including 6 questions may be considered, and it may be assumed that all questions are auto answered and scored, e.g., according to:

TABLE 3

| Question | | Score | Max Possible |
|---|---|---|---|
| Number | Answer | Earned | Score |
| 1 | Yes | 7 | 7 |
| 2 | No | 0 | 4 |
| 3 | Yes | 5 | 5 |
| 4 | No | 0 | 3 |
| 5 | Yes | 2 | 2 |
| 6 | No | 4 | 4 |
| | | Total | Total Max |
| | | Score | Possible Score |
| | | Earned: 18 | of Form: 25 |

Using the example formulas provided herein:

$$Overall Percentage Score of Form = ( 7 + 0 + 5 + 0 + 2 + 4 ) / ( 7 + 4 + 5 + 3 + 2 + 4 ) * 100 = 18 / 25 * 100 = 72 \% \qquad ( Eq . 4 )$$

Additional or alternative scoring procedures, including additional or alternative steps and/or formulas, may be included and used in different embodiments of the invention.

Tables 4-9 show example data structures that may be used in some nonlimiting embodiments of the invention.

```
TABLE 4
Interaction Metadata Entity
    {
      ″interaction_id″:″78346387-9838-k3kj-98jj-3489757889″,
      ″tenant_id″:″iuj238h2-kj29-kj23-j23k-iou203iu3222″,
      ″start_time″:″2020-11-10 12:34:55.668 Z″,
      ″end_time″:″2020-11-10 12:38:12.345 Z″,
      ″channel″:″PHONE″,//other possible value - EMAIL/CHAT/SMS
      ″direction″:″INCOMING″,//other possible values - outgoing
      ″customer_id″:″12787248974017124″,
      ″ani″:″334 445 9893″,
      ″dnis″:″374 875 9832″,
      ″agent_users″:[
        {
          ″id″:″98398221-2323-edb0-8732-372372871972″,
          ″skill″:″TERM_INSURANCE″.
          “team_id”: “65267126-0923-kj22-2652-983kjnbv38382”
        },
        {
          ″id″:″11e70afb-172e-edb0-b9f3-0242ac110002″,
          ″skill″:″ACCOUNTING”,
          “team_id”: “65267126-0923-kj22-2652-983kjnbv38382”
        }
      ],
      ″recordings″:[
        {
          ″id″:″09d58205-9333-4f76-ad8f-2628a6707c0a″,
          ″type″:″audio″,
          ″start_time″:″2020-11-10 12:34:55.668 Z″,
          ″end_time″:″2020-11-10 12:35:52.268 Z″,
          ″media_location″
  ″ftp://recorded_media_files/2394823098423/part1.mp4″
        }
      ]
    }
```

```
TABLE 5
Interaction Transcript Entity
      {
        ″id″: 124553,
        ″interactionId″: ″ad86d017-19a7-405f-be50-90de2035213d″,
        “tenantId″: ″11ed1163-441d-0360-ac0b-0242ac110005″,
        ″utterences″: [
          {
            ″id″: 1,
            ″speakerType″: ″customer″,
            ″speakerId″: ″customer@socialmedia.com″,
            ″utterenceText″: ″I need help with password″,
            ″timestamp″: ″2022-09-17 19:08:16.259″
          },
          {
            ″id″: 2,
            ″speakerType″: ″Agent″,
            ″speakerId″: ″Bob″,
            ″utterenceText″: ″Sure, how can I help you?″,
            ″timestamp″: ″2022-09-17 19:08:16.712″
          },
          {
            ″id″: 3,
            ″speakerType″: ″customer″,
            ″speakerId″: ″customer@socialmedia.com″,
            ″utterenceText″: ″I forgot my password″,
            ″timestamp″: ″2022-09-17 19:08:21.349″
          },
          {
            ″id″: 4,
            ″speakerType″: ″Supervisor″,
            ″speakerId″: ″Alice″,
            ″utterenceText″: ″Show empathy and suggest using self-service portal
  https://nice.com″,
            ″timestamp″: ″2022-09-17 19:08:26.456″
          },
    {
                ″id″: 5,
                ″speakerType″: ″Agent″,
                ″speakerId″: ″Bob″,
                ″utterenceText″: ″I'm sorry to hear that. You can reset it at our website
    https://nice.com″,
                ″timestamp″: ″2022-09-17 19:08:29.967″
              }
        ]
      }
```

TABLE 6

```
User Entity
    {
      ″user_id″:″98398221-2323-edb0-8732-372372871972″,
      ″tenant_id″:″iuj238h2-kj29-kj23-j23k-iou203iu3222″,
      ″first_name″ : ″John″,
      ″last_name″ : ″Snow″,
      ″middle_name″:″Dominik″,
    ″role″:″AGENT
    }
Team
  {
    “team_id”:”09d58205-9333-4f76-ad8f-2628a6707c0b”
    “team_name”:”Falcons”,
    “team_department”:”RnD”
  }
Group
  {
    “group_id”:”84267921-8745-344f-13af-2628a6707c0b”
    “group_name”:”Falcons Assessors”,
  }
Skill
  {
    “skill_id”:”3983242-jk33-iu33-65ee-8237782937423”
    “skill_name”:”Billing”
    }
Tenant
  {
    “tenant_id”:”90384jj4239-kj23-vcv4-adwe-nb324mn3b4mb4”
    “tenant_name”:”ABC Corportation”
  }
```

```
TABLE 7
Form Templates and User Forms Entity
    {
      “formId”: “27b3142c-6734-4aaf-8135-ff48febc452b”,
      “formName”: “Sample Form”,
      “elements”: [{
          “id”: 1068409281660,
          “type”: “section”,
          “uuid”: “92bac21b-ba97-452b-9248-3b6942f9a7cd”,
          “numbering”: 1,
          “isScorable”: true,
          “title”: “Greeting and introduction”,
          “questions”: [{
            “id”: 1055545296066,
            “type”: “yesno”,
            “uuid”: “861cec91-25fc-41b0-b823-a480dd8f2587”,
            “numbering”: “1.1”,
            “question”: “Was the agent professional and polite during
  the call?”,
            “maxScore”: 1,
            “isScorable”: true,
            “isCriticalQuestion” = true,
            “choiceList”: [{
              “score”: 1,
              “criticalQuestionCorrectChoice”: true,
              “id”: “1”,
              “label”: “Yes”,
            },{
              “score”: 0,
              “id”: “2”,
              “label”: “No”,
            }],
          },{
            “id”: 1055545296067,
            “type”: “yesno”,
            “uuid”: “861cec91-25fc-41b0-b824-a480dd8f1234”,
            “numbering”: “1.2”,
            “question”: “Did the agent asked right questions to identify
  customers pain points?”,
            “maxScore”: 1,
            “isScorable”: true,
            “isCriticalQuestion” = false,
            “choiceList”: [{
              “score”: 1,
              “criticalQuestionCorrectChoice”: false,
              “id”: “1”,
              “label”: “Yes”,
            },{
              “score”: 0,
              “id”: “2”,
              “label”: “No”,
            }],
          }]
        }
    }
```

```
TABLE 8
Auto Assessment Score Entity
    {
      ″assessmentScoreId″: ″ca1ec430-e4c6-4469-9578-0b95b6451d25″,
    ″assessmentId″: ″907cd17a-ba22-44b6-9504-23d269246851″,
    ″formId″: ″27b3142c-6734-4aaf-8135-ff48febc452b″,
    ″maxPossibleScore″ = 80,
    ″scoreEarned″ = 71,
    ″scorePercent″ = 88.75
    }
Auto Assessment Answers Entity
    {
      ″assessmentId″: ″907cd17a-ba22-44b6-9504-23d269246851″,
      ″formId″: ″27b3142c-6734-4aaf-8135-ff48febc452b″,
      ″answers″: [{
          ″questionId″: 1055545296066,
          ″questionType″: ″yesno″,
          ″questionUUID″: ″861cec91-25fc-41b0-b823-
  a480dd8f2587″,
          ″questionNumber″: ″1.1″,
          ″questionTitle″: ″Was the agent professional and polite
  during the call?″,
          ″answer″: {
            ″score″: 1,
            ″id″: ″1″,
            ″text″: ″Yes″,
          },
          ″justification″: ″The agent started the conversation with a
        standard greeting: Hello, thank you for calling out contact center.
        How may I assist you today? at timestamp ′2024-04-01T10:00:00Z′.
        This shows that the agent was polite and professional.″
        },{
          ″questionId″: 1055545296067,
          ″questionType″: ″yesno″,
          ″questionUUID″: ″861cec91-25fc-41b0-b824-
  a480dd8f1234″,
          ″questionNumber″: ″1.2″,
          ″questionTitle″: ″Did the agent asked right questions to
        identify customers pain points?″,
          ″answer″: {
            ″score″: 1,
            ″id″: ″1″,
            ″text″: ″Yes″,
          },
          ″justification”: ″The agent asked the customer to explain the
        problem in more details at timestamp ′2024-04-01T10:01:00Z′.″
        }]
      }
    }
```

```
TABLE 9
Auto Assessment Planner Configuration Entity
  {
    ″id″: ″70180d11-9fce-4c38-b58a-627cfa5611ab″,
    ″name″: ″Team G24 auto assessment plan″,
    ″description″: ″This assessment process is for assessment of long calls″,
    ″form″: ″6511bb18-325e-4c93-a50f-b8bd35f14672″,
    ″filter″: {
      ″call_duration″: {
        ″condition″: ″gte″,
        ″valueSeconds″: 500
      },
      ″channel″: {″chat″, ″voice″},
      ″direction″: ″INBOUND″,
    ″agents″: {
      ″teams″: {″ca995b14-439d-4faf-bd59-07bb354bf27d″},
      ″groups″: { }
    }
  }
Form Test Result Entity
    {
      ″testId″: ″907cd17a-ba22-44b6-9504-23d269246851″,
      ″formId″: ″27b3142c-6734-4aaf-8135-ff48febc452b″,
      ″answers″: [{
          ″questionId″: 1055545296066,
          ″questionType″: ″yesno″,
          ″questionUUID″: ″861cec91-25fc-41b0-b823-
  a480dd8f2587″,
          ″questionNumber″: ″1.1″,
          ″questionTitle″: ″Was the agent professional and polite
  during the call?″,
          ″answer″: {
            ″score″: 1,
            ″id″: ″1″,
            ″text″: ″Yes″,
          },
          ″justification″: ″The agent started the conversation witha
        standard greeting: Hello, thank you for calling out contact cetner..
        How may i assist you today? at timestamp ′2024-04-01T10:00:00Z′.
        This shows that the agent was polite and professional.″
        },{
          ″questionId″: 1055545296067,
          ″questionType″: ″yesno″,
          ″questionUUID″: ″861cec91-25fc-41b0-b824-
  a480dd8f1234″,
          ″questionNumber″: ″1.2″,
          ″questionTitle″: ″Did the agent asked right questions to
        identify customers pain points?″,
          ″answer″: {
            ″score″: 1,
            ″id″: ″1″,
            ″text″: ″Yes″,
          },
          ″justification”: ″The agent asked the customer to explain the
        problem in more details at timestamp ′2024-04-01T10:01:00Z′.″
        }]
      }
    }
```

It should be noted that additional or alternative example data structures may be used in different embodiments of the invention.

Embodiments of the invention may improve technology for example by providing automatic, accurate and nuanced analyses of large volumes of interactions or data items based on a fine grained review of the contents of these items—as opposed to, e.g., a coarse grained review based on only on strict rules and/or logic. By leveraging the advanced natural language processing capabilities of an LLM, Some embodiments may streamline quality assurance processes across diverse disciplines. Furthermore, the LLM can continuously learn and adapt from new data, which may improve its evaluations over time and ensure that embodiments stay responsive to evolving data landscapes.

Some embodiments may include transmitting one or more output data items to a remote computer over a communication network based on the calculated score.

For example, some embodiments may transmit an alert and/or report, which may for example include calculated scores or computed metrics and/or answers provided by the machine learning model or LLM, to one or more computer systems remotely connected over a network (such as for example one of the systems or components described with regard to FIGS. 3-5). Some embodiments may send or transmit computerized requests or commands based on which computerized and/or automated actions may be taken. This may be done based on additional conditions and/or criteria. For example, if a score calculated for a given data item may be lower than a threshold (of, e.g., 0.9), some embodiments may output and send/transmit a data item including command X (where X may be, e.g., a command to route an interaction by an ACD component to one or more agents). Various output data item or element contents and/or formats may be used in different embodiments.

Some embodiments of the invention may execute one or more computer actions or processes, e.g., based on evaluation and/or scoring of data items such as for example described herein. For example, some embodiments may dial or route a call or interaction based on an evaluation or scoring of a given data item (and/r based on output data items or elements including appropriate computerized requests or commands generated or produced according to calculated or computed scores or metrics). For instance, if a score calculated for a given data item is below a predetermined threshold (such as, e.g., 5 points), embodiments may initiate or route a call or interaction (e.g., using a voice or digital channel and/or using a outbound dialer or ACD) between the customer included in the evaluated interaction or call and a different call center agent, or an agent different than the agent included in the evaluated interaction. In such manner, for example, embodiments may improve the chances an interaction or call is handled successfully or satisfactorily, e.g., by ensuring future required calls or interactions are not further handled by agents who may be responsible for the call or interaction having a low score. Additionally or alternatively, some embodiments may send an alert or report to a supervisor or manager device, notifying of the relevant interaction having a low score and/or automatically schedule a coaching session for the agent associated with the call, e.g., to improve the agent's handling of calls or interactions.

It should be noted that additional or alternative automated actions and/or computer processes may be performed, executed, or conducted based on evaluations, assessments and/or scoring according to different embodiments of the invention.

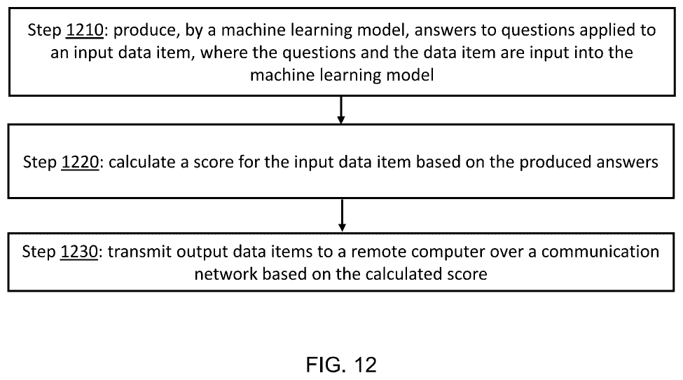

FIG. 12 is a flow diagram of an example method of evaluating data items using a machine learning model according to some embodiments of the invention. In step 1210, some embodiments may produce, by a machine learning model, answers to questions applied to an input data item, where the questions and input data item are input to or fetched into the machine learning model (such as for example in one or more prompts), e.g., as described herein. Embodiments may calculate a score for the input data item based on the produced answers (step 1220), and send or transmit one or more output data items (e.g., reports or computerized commands) to a remote computer over a data or communication network based on the calculated score (step 1230). Additional or alternative operations and/or workflows may be used in different embodiments.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method of evaluating data items using a machine learning model, the method comprising, using one or more computer processors:
producing, by a machine learning (ML) model, one or more answers to one or more questions, wherein the one or more questions are applied to an input data item, and wherein the one or more questions and the input data item are input to the machine learning model;
calculating a score for the input data item based on one or more of the produced answers; and
transmitting one or more output data items to a remote computer over a communication network based on the calculated score.

2. The method of claim 1, wherein the input data item comprises a transcript of a call, and wherein the method comprises routing, by an automatic call dialer (ACD) the call to an agent computing device.

3. The method of claim 1, wherein the questions are sorted in a plurality of levels, and wherein the calculating of a score is performed based on one or more of the answers corresponding to one or more of the levels.

4. The method of claim 1, wherein one or more of the questions are included in a form, the form generated using a graphical user interface (GUI), wherein the form is stored in a structured query language (SQL) database.

5. The method of claim 4, wherein the producing of one or more of the answers is performed based on an automatic evaluation plan, wherein the evaluation plan comprises the form and one or more filtering conditions, and wherein the producing of one or more answers is triggered based on a predefined time interval.

6. The method of claim 1, comprising producing, by the ML model, a justification to one or more of the answers.

7. The method of claim 3, wherein the plurality of levels comprise a level of critical questions, wherein the calculating of a score comprises: if one or more critical questions are unanswered, assigning a score of zero to the data item.

8. A computerized system for evaluating data items using a machine learning model, the system comprising:
a memory; and
one or more computer processors configured to:
produce, by a machine learning (ML) model, one or more answers to one or more questions, wherein the one or more questions are applied to an input data item, and wherein the one or more questions and the input data item are input to the machine learning model;
calculate a score for the input data item based on one or more of the produced answers; and
transmit one or more output data items to a remote computer over a communication network based on the calculated score.

9. The system of claim 8, wherein the input data item comprises a transcript of a call, and wherein one or more of the processors are configured to route, by an automatic call dialer (ACD) the call to an agent computing device.

10. The system of claim 8, wherein the questions are sorted in a plurality of levels, and wherein the calculating of a score is performed based on one or more of the answers corresponding to one or more of the levels.

11. The system of claim 8, wherein one or more of the questions are included in a form, the form generated using a graphical user interface (GUI), wherein the form is stored in a structured query language (SQL) database.

12. The system of claim 11, wherein the producing of one or more of the answers is performed based on an automatic evaluation plan, wherein the evaluation plan comprises the form and one or more filtering conditions, and wherein the producing of one or more answers is triggered based on a predefined time interval.

13. The system of claim 8, wherein one or more of the processors are to produce, by the ML model, a justification to one or more of the answers.

14. The system of claim 10, wherein the plurality of levels comprise a level of critical questions, wherein the calculating of a score comprises: if one or more critical questions are unanswered, assigning a score of zero to the data item.

15. A method of assessing data elements using a large language model (LLM), the method comprising, using one or more computer processors:
generating, by an LLM, one or more replies to one or more questions, wherein the one or more questions are applied to an input data element, and wherein the one or more questions and the input data element are input to the LLM;
computing a quality metric for the input data element based on one or more of the generated replies; and
sending one or more output data element to a remote computer over a data network based on the computed metric.

16. The method of claim 1, wherein the input data element comprises a transcript of an interaction, and wherein the method comprises routing, by an automatic call dialer (ACD) the interaction to an agent device.

17. The method of claim 1, wherein the questions are classified into a plurality of tiers, and wherein the computing of a quality metric is performed based on one or more of the replies corresponding to one or more of the tiers.

18. The method of claim 1, wherein one or more of the questions are included in a form, the form generated using a user interface, wherein the form is stored in a structured query language (SQL) database.

19. The method of claim 4, wherein the generating of one or more of the replies is performed based on an evaluation plan, wherein the plan comprises the form and one or more filtering criteria, and wherein the generating of one or more replies is initiated based on a predefined time period.

20. The method of claim 1, comprising generating, by the LLM, an explanation to one or more of the replies.
